(19) United States
(12) Patent Application Publication
(10) Pub. No.: US 2013/0217449 A1
(43) Pub. Date: Aug. 22, 2013

(54) CELLULAR TELEPHONE HEADSET WITH INTEGRATED FERRITE BEAD AND INTEGRATED CLIP FOR REDUCTION OF MICROWAVE RF SIGNAL MIGRATION UPON CELLULAR TELEPHONE HEADSET WIRES.

(71) Applicant: Harry V. Lehmann, Novato, CA (US)

(72) Inventor: Harry V. Lehmann, Novato, CA (US)

(21) Appl. No.: 13/773,349

(22) Filed: Feb. 21, 2013

Related U.S. Application Data
(60) Provisional application No. 61/601,422, filed on Feb. 21, 2012.

(51) Int. Cl. H04M 1/02

(52) U.S. Cl. CPC H04M 1/0258
USPC 455/575.2

(57) ABSTRACT

Cellular device headsets commonly include a clip such that the cord (wire) from the headset to the cellular device can be attached to an article of clothing as worn by the consumer, including for the purpose of establishing a stable position and set distance for the microphone of the headset. A ferrite (or other composition of similar effect) bead having a signal choking capacity may be integrated into such a clip, for a resulting hybrid device which by stopping the propagation of microwave signal along the wire also serves to attach the wire to the clothing of the end user in the same manner as such a clip would normally be used.

### CROSS REFERENCES

The application is a non-provisional application of and claims priority benefit of co-pending provisional application No. 61/601,422 entitled CELLULAR TELEPHONE HEADSET WITH INTEGRATED FERRITE BEAD AND INTEGRATED CLIP FOR REDUCTION OF MICROWAVE RF SIGNAL MIGRATION UPON CELLULAR TELEPHONE HEADSET WIRES, filed on Feb. 21, 2012. The entirety of which is herein incorporated by reference.

### BACKGROUND

Substantial empirical research demonstrates a correlative relationship between close, exposure to cellular telephone microwave signal and physiological changes sometimes associated with deterioration in human health. The relationship between microwave signal from cellular devices and health is not controversial, though the extent and type of such relationship remains debated. That the fact of such a relationship is noncontroversial is demonstrated by the presence of warnings in the supporting documentation sold with all or most cellular devices. Typically a small booklet is deployed to the consumer at the point of sale in packaged company with the sold cellular device. In some other instances, particularly with one manufacturer, the paper documentation is slight, but the end user is directed to descriptive materials, corresponding in practical effect to a user˜s manual. In pertinent point˜the user's manuals sold with cellular devices in the United States, Europe˜and elsewhere contain concise warnings to the consumer based upon a testing regime called Specific Absorption Rate, which is the industry-accepted criteria for the measurement of projected risk from exposure to cellular devices. Below are sample industry defined as safe distances, based upon an industry standard expectation of a maximum of 1.6 W/kg SAR value over six minutes of continuous use.

While the industry standards for such distances are typically stated as being in reference to the risks of heat accumulation from microwave induced vibration e˜slow cook”), many• credible scientific studies have empirically demonstrated the existence of a direct relationship between the non-ionizing radiation from cellular devices• and physiological changes in the bodies of the users of cellular telephones, including the head and brain. Thus,an article just published in the Journal Of The American Medical Association (JAMA), .titled Effects of Cell Phone Radiofrequency Signal Exposure on Brain Glucose Metabolism, written by a team of scientists from the National Institutes of Health, headed by Nora D˜Volkow.

As stated in the Abstract (httu://jarua.runa-assn.org/content/305/8/808). published on Feb. 23,2011, the Volkow team found that: “50-minute cell phone exposure was associated with increased brain glucose metabolism in the region closest to the antenna.” The ultimate significance of this new JAMA study is that the cellular telephone industry has heretofore asserted that there was no possible direct effect upon the brain from cellular telephone exposure˜the Volkow study clearly shows a direct relationship between cellular telephone use and brain metabolism, long before the levels of radio wave exposure necessary to generate heat.

Many empirical studies have by demonstrated physical effect, such as the work of Dr. Hemy Lai at The University of Washington, the Lund University experiments, and many others. Thus? in a 1983 article entitled Au. Optical Method for Investigating the Microwaye Characteristics of DNA and other Biomolecules in Solution, by Mays L. Swicord and Christopher C. Davis, as published in the professional journal Bioelectromagnetics. experimental results were reported which determined that: u A significant increase in the absorption of DNA solutions as compared with pure water has been observed that is consistent with microwave absorption by the longitudinal mode of the double helix.‘-’ Thus, in their conclusion Swicord and Da˜s state that: ‘!However, the results presented in this work are in good agreement with the Prohofsky model of acoustic mode absorption by varying lengths of DNA. Prohofsky and Van Zandt predicted that 450 to 2000 base pair segments of synthetic DNA should absorb 10˜ to 102 times as strongly in the microwave region as an equivalent mass of water with a decrease in peak absorption due to water damping. The 1.7% dilution of DNA investigated by PFLOH spectroscopy in this work indicated a 40% increase in absorption above pure water at −8 GHz and at 10 to 12% increase at 12 GHz. The measured DC conductance of this DNA sample was quite low yet its absorption coefficient was still 25% higher at 8 GHz than a saline solution of 20 times greater DC conductance. We conclude therefore that the observed absorption of the DNA solution does not come from ionic behavior. The observed absorption is suggestive of direct microwave absorption by the longitudinal acoustic mode of the double helix discussed by Prohofsky and co-workers. Based on the concentration of the DNA solution which gave 40% more absorption than pure water at 8 GHz˜the microwave absorption of DNA at this frequency is 24 times greater than an equivalent mass of water.”

This very little discussed experimental finding˜that there are many orders of magnitude of increase in microwave absorption when DNA is present, may likely explain the considerable body of experimental evidence strongly indicating a relationship between. long term cellular telephone use, and diseases involving DNA strand abnormality, such as brain cancer. Scientific studies [i.e. H. Lai et al, from the-University of Washington, 1984, 1988, and as presented in 1998˜Vienna, Austria, and 2009 in Stavanger, Norway; O. Johansson, Associate Professor, Dept. of Neuroscience of the Karolinska Institute˜Stockholm, and Professor, Royal Institute of Technology, Stockholm, as presented in 2009 at Stavanger, Norway; C˜1F. Blackman a founder of the Bioelectromagnetics Society, as presented in 2009, at Stavanger, Norway; Martin Blank, Ph.D., Associate Professor, Columbia University˜as presented in 2009 Stavanger, Notway, Fr˜Adlkofer, M.D., doctorate from the Max Planck Institute for Biochemistry as presented at Stavanger Norway, 2009, also the' following presenters at the International EMF Conference 2009 at Stavanger, Norway: Lukas h. Margaritis, Ph˜D, Greece; Elihu D. Richter˜:MD, M.P.H., Israel; Alvaro Agusto A. de Salles, Ph.D., Brazil; Fredrik Soderqvist, Ph.D., Sweden, Ymi G. Grigoriev M.D. Sci., Russia; Anton V. Merkulov Ph.D., Russia], have shown potential health risks, in some instances showing DNA •breakage, as associated with human exposure to non-ionizing radio wave sources, including but not. limited to those emitted from mobile telephone devices and handsets, including but not limited to cellular telephones.

In addition to scientific findings as referenced in part above, the perception of such a relationship as a matter of belief is also a market force, with millions of consumers regularly engaged in the purchase of devices intended to, or alleged to, reduce the effect of cellular telephone generated non-ionizing radiation upon living tissues. Thus, in addition to the fact that there now exist substantial and extensive scientific publications showing a direct causal relationship between close cellular telephone use and changes in Hunan physiology, the public perception of such a relationship has become a market force having value.

Consequently a huge world market has developed for devices which reduce the exposure .of the human user to cellular device generated non˜ionizing radiation. Ubiquitous in this market is the cellular telephone• headset, very commonly sold as original equipment with cellular devices. The use of the term “headset” in this document is intended to include and all wired devices such that audible or visible signal is received by a device equipped•with ear speakers, commonly called earphones, or ear “buds” similar small devices containing miniature speakers, including but not limited to such devices equipped with microphones for the Purpose of conversation through cellular or other radio devices. Such that, in example, Blackberry branded cellular devices are commonly sold with a booklet which describes the SAR of the device and provides time-in-use warnings consistent therewith, and a headset in the sealed package provided for sale, which allows the end user to distance himself or herself from the cellular device during use.

The use of headset is very frequently suggested, as a good method for reducing the consumer's exposure to non-ionizing radiation from cellular devices. However, recent findings have disclosed an important limitation in the effectiveness of headsets as a means of reducing such radiation exposure, as described below. The purpose of the Subject matter herein claimed˜a cellular telephone headset with ferrite bead, is to greatly increase the ability of cellular telephone headsets to reduce the extent to which the head of the cellular telephone consumer is exposed to the non-ionizing radiation emanating from such devices.

As can be seen from a simple Internet search, some persons concerned with the potential effects of cellular device non-ionizing radiation have learned to their dismay that the cellular broadcast signals, incoming and outgoing, are transmitted and :received through the wires of the headsets. This finding has been independently verified and would not be surprising to many persons familiar with wave propagation from radio devices of various sorts.

It is well established in the open literature that any wire which is part of, or connected to a radio wave generating device˜whatever its name (Ethem.et cable, speaker cable˜headset wire˜video cable etc.) will always parasitically serve as an “accidental antenna” for the device involved. This is fact extremely well understood in any community of interest in which radio broadcast is a factor, from signal communications to the operation of radio controlled model aircraft. Further, the phenomena are not limited to devices built for the ultimate purpose of radio broadcast, since inadvertent radio signal will result from a vast number, some would say all, devices where electrical current is propagated over metallic media.

Industry understanding of such opportunistic wave propagation, typically perceived as unwanted signal interference has lead industry to produce various solutions intended to isolate an intended broadcast frequency from competing sources of broadcast interference. Heretofore, the purpose of all such devices has been to ensure freedom of the intended transmission from frequencies other than the intended frequency. One method for such approaches is careful antenna construction, so that the antenna is carefully calibrated to limit received and forwarded signal to the intended wave length. However, even with the most careful dimensional construction, stray signal will intrude, as has been experienced from time to time by any motorist listening to a weak station, when passing an area of RF .interference, such as a public utility sub-station, or when driving under high voltage wires, for two examples of many.

Heretofore, all efforts in this regard in industry have been articulated for the purpose of assuring maximum signal fidelity, meaning the elimination of unintended radio waves from received signal and elimination of stray wave from signal as received, when in transmission to amplification devices as necessary to signal conversion from electric/electronic signal tQ audible sound or other recognizable pattern, transmitted and received This issue has been copiously treated in the area of Ham Radio for one example, and methods have included the “Air Balun” (wound wires in a spiral adhered “donut”-like configuration through which the intended signal is configured to pass) as well as metallic “chokes” of which the ferrite choke is the leading and most common example. Heretofore, these signal choking devices have been applied to radio antennas for the purpose of stripping out erratic signal from the antenna such that an enhanced clarity will of signal will result to the next in line amplification equipment) a means of obtaining enhanced signal accuracy. Similar choke devices, of ferrite and other materials, have long been offered in industry for use where high signal fidelity is desired in closed systems, such as in high fidelity sound equipment, such as the wiring from a DVD player to an amplifier. In all prior articulations of such technology, the goal, and so far as known to the undersigned the sole goal, has. been to achieve enhanced fidelity of signal; meaning the highest obtainable accuracy between the sound or signal as broadcast, and in turn as ultimately experienced by the end user, and such use of “air baluns” and “ferrite chokes” has taken place for generations and is in a general sense in the public domain, though particular configurations may from time to time be sufficiently unique in design and effect so as to gain patent status-all, however, have heretofore been for the purpose of obtaining signal purity.

### BRIEF DESCRIPTION OF THE DRAWINGS

FIG. 1A is an illustration of a ferrite bead with a clip.

FIG. 1B is an illustration of the ferrite bead with clip in use.

### DETAILED DESCRIPTION

Until very recently, it has been the generally prevailing belief within the wireless industries, by this tern meaning to include all broadcast related industries, that except where heat results from microwave exposure over time, non-ionizing radiation was necessarily harmless to living tissue.

This belief in the harmlessness of non˜ionizing radiation to living tissue is rational (though recently clearly dis-proven) and simple to state. In the heretofore generally accepted Scenarios; 1) Tissues are made of molecules, and: 2) Molecules are made of atoms, and: 3) Atoms have electron shells, and molecules are formed or changed, and atomic adhesions occur forming compounds, only as a result of changes in electron shell stature .(called ionization), and: 4) By virtue of the character of its waves, radiation in the non-ionizing” spectrum cannot affect any change in electron shell formation, such that: 5) Compounds cannot be changed or destroyed by such “non-ionizing”•radiation (except by resulting heat), so that: 6) It is impossible as a matter of physics for non-ionizing radiation to have health consequence in animals, including humans. This remains a component of industry outlook.

Very unfortunately. consistent and replicable empirical findings have shown the “can't hwi living tissue” belief system, though internally rational, to be wrong. The empirical reality as shown in some small part by the scientific sources cited in the General Introduction section of this Provisional Patent Application, is that non-ionizing radiation can and does have an effect on living tissue˜and specifically including the brain. The fact that non-ionizing radiation has genetic effects has been shown by the work of Lai at the University of Washington School of Medicine and many others, including the work at Lund University in Sweden, one amongst many studies showing an effect on the brain (AMA cited here), in that instance the now frequently encountered effect of violation of the blood/brain barrier. However, industry and individual inventors have not previously used devices resembling the effect of the ferrite choke for the purpose of stopping accidental wave propagation for the intrinsic purpose of stopping such propagation, independent of any concern for, or effect upon, signal purity within the wave itself. Consequently. And consistent with the generally prevailing industry view that non-ionizing radiation cannot result in medical harm, cellular telephone headsets do not as yet come equipped with baluns or ferrite choke-type equipment.

For a cellular device headset the wires of which, built for the transmission of electrical signal by such insulated wires, such that the headset wires have installed upon them, a bead or wrapper or other means of attachment to the wire, in form resembling a ferrite choke, such that the opportunistic propagation of cellular signal up the wire˜over the body and towards the head is stopped or limited. Embodiments for such signal interdicting purposes where the bead is constructed of ferrite or any other metallic or non-metallic element or composition capable of having such ability to stop or limit unintended action of the headset wires as an antenna.

Another embodiment for use with a cellular device headset the wires of which, built for the transmission of electrical signal by such insulated wires˜such that the headset wires have installed upon them, a Balun constructed of wire in a form resembling an “air balun” as previously used in intentionally constructed radio antenna, such that the opportunistic or otherwise defined propagation of cellular signal up the wire, over the body and towards the head is stopped or limited. This embodiment asserted for such signal interdicting purposes where the Balun is constructed such that it capable of having the ability to stop or limit unintended action of the headset wires as an antenna.

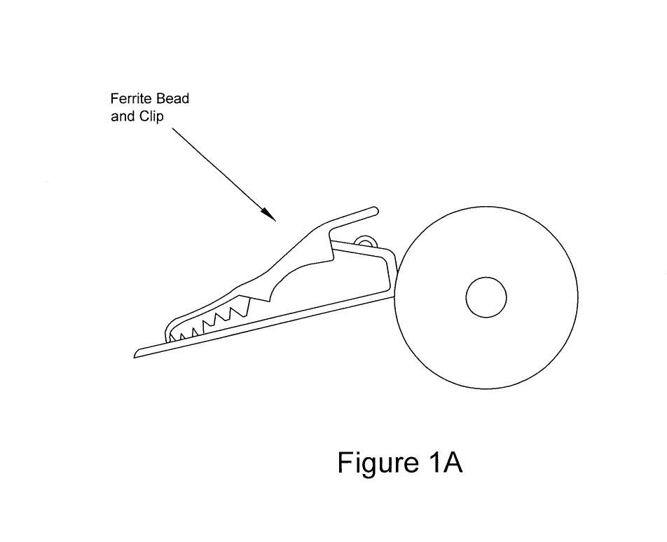

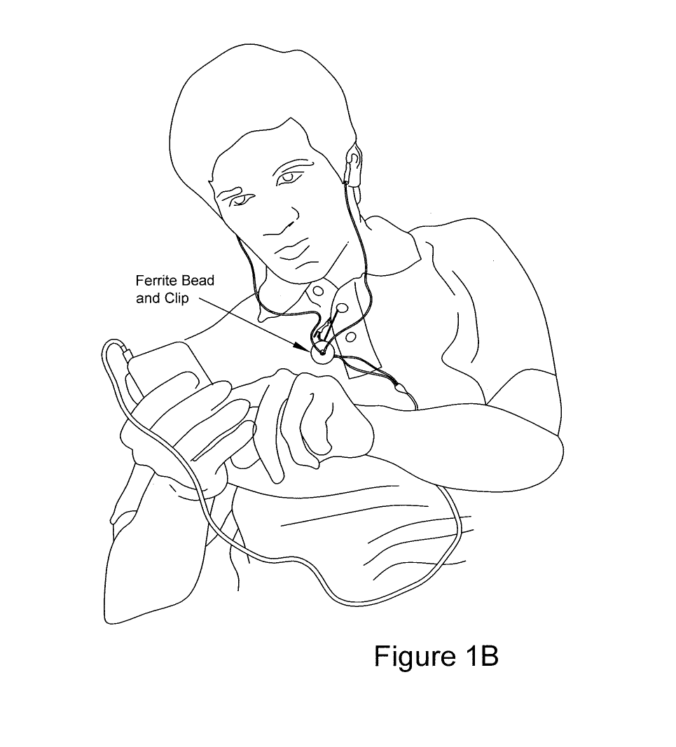

Yet another embodiment is shown in in FIGS. 1A and 1B. Cellular device headsets commonly include a clip˜such that the cord (wire) from the•headset to the cellular device can be attached to an article of clothing as worn by the consumer, including for the purpose of establishing a stable position and set distance for the microphone of the headset. This embodiment as shown is a combination device, such that a ferrite (or other composition of similar effect) bead having a signal choking capacity may be integrated into such a clip, for a resulting hybrid device which by stopping the propagation of microwave signal along the wire also serves to attach the wire to the clothing of the end user in the same manner as such a clip would normally be used.

I claim:

1. An apparatus comprising:
a mobile device,
a microphone
an earpiece,
a wire connecting the mobile device to the microphone and earpiece and a clip adapted to affix the wire to an article of clothing worn by a user of the mobile device,
wherein the clip comprises an integrated RF filter and the wire passes through the RF filter, thus preventing unwanted propagation of RF signals to the microphone or earpiece.

2. The apparatus of claim 1, wherein the RF filter is a ferrite bead and the wire passes through the center of the bead and is attached to the clip via the ferrite bead.

3. The apparatus of claim 2, wherein the clip comprises a two halves of the ferrite bead connected by a spring.
